(19) United States
(12) Patent Application Publication
(10) Pub. No.: US 2010/0253025 A1
(43) Pub. Date: Oct. 7, 2010

(54) Utility Hand-Truck

(76) Inventor: Don Smith, Malibu, CA (US)

Correspondence Address: KLEIN, DENATALE, GOLDNER, COOPER et. al., P.O. BOX 11172, BAKERSFIELD, CA, 93389-1172, US

(21) Appl. No.: 12/725,598

(22) Filed: Mar. 17, 2010

Related U.S. Application Data
(60) Provisional application No. 61/161,008, filed on Mar. 17, 2009.

(51) Int. Cl. B62B 3/02

(52) U.S. Cl. 280/47.27

(57) ABSTRACT

A hand truck has a front load platform, a rear load platform, and a pair of lower wheel assemblies and a pair of upper wheel assemblies. The load platforms and the wheel assemblies fold and nest into the frame of the hand truck, resulting in a stored position in which the thickness is approximately the same as the side rails of the hand truck. Raising and lowering of the front load platform causes the lower wheel assemblies to move back and forth from the operational position to the storage position. Likewise, raising and lower of the rear load platform causes the upper wheel assemblies to move back and forth from the operational position to the storage position.

### CROSS-REFERENCE TO RELATED APPLICATIONS

This application claims domestic priority to U.S. Provisional Patent Application 61/161,008 filed on Mar. 17, 2009 and to PCT/US2009/005093 filed on Sep. 11, 2009, which claims priority to U.S. Provisional Application No. 61/191,958 filed on Sep. 11, 2008.

### BACKGROUND OF THE INVENTION

### 1. Field of the Invention

The present invention generally relates to devices for transporting equipment for sports, music, tools and other heavy and/or unwieldy objects, such as hand trucks, hand carts, dollies, etc. For example, transporting scuba equipment, divers' bags, projector cases, computers, etc.

More particularly, the present invention relates to a wheeled hand truck which is capable of carrying objects on both the front side and the back side which is capable of balancing the loads to minimize the weight supported by the user and to facilitate manipulating the hand truck from a standing position to a transport position. In addition the present invention relates to hand trucks which are easily collapsible such that it might be stored in small spaces, such as within a duffel bag, suit case, or overhead compartment of an airplane.

The use of hand trucks is well known. However, many hand trucks suffer from the same deficiencies. Most hand trucks only carry cargo on the front side. Many hand trucks will remain standing in a vertical position, which allows the cargo to be loaded on the nose plate with the hand truck is in a vertical position. However, in order to move the load, the handle of the hand truck must be pushed down, sometimes with great effort, to raise the nose plate and lift the load off of the ground. If the load is too heavy, raising it off of the ground can require substantial effort. However, once the user has raised the load, the load imposes a moment on the hand truck urging it either back to a vertical position or to a horizontal position. Thus, the user must either hold the handle up or push it down to maintain the equilibrium of the hand truck as the load is transported.

Hand trucks also tend to be bulky and not easily stored or transported. Those which do collapse tend to be limited to light service and not capable of transporting heavier loads.

### SUMMARY OF THE INVENTION

Embodiments of the disclosed hand truck satisfy the needs identified above. The disclosed hand truck generally comprises a frame comprising a pair of side members and a handle member. While the device may be constructed from various materials, the inventor herein has found that the combination of stainless steel, aluminum, and glass filled nylon plastic provides a light weight hand truck which has sufficient strength to carry loads of up to 300 pounds. The handle member extends between the side members. The handle may be flat or ergonomically shaped to enhance comfort and gripping surface.

An upper pair of pivotally attached wheel assemblies are attached to the frame, and a lower pair of pivotally attached wheel assemblies are attached to the frame beneath the upper pair. The respective pairs of wheels within the upper and lower wheel assemblies are sized such the upper pair of wheels has a larger diameter than the lower pair of wheels such that both pairs of wheels are engaging the ground surface when the load is raised off of the ground and ready to be transported. This configuration allows the load to be supported by the upper pair of wheels during transportation, rather than supported by the user supporting the load by holding the handle. The addition of the upper pair of wheels allows the majority of the weight of the load to be carried by the hand truck itself, thus removing stress from the lower back of the user and reducing the risk of back injury. An additional set of wheels may optionally be disposed between the lower wheels for use on soft or incompetent ground surfaces such as sand, gravel, mud, snow, etc.

A plurality of load platforms are pivotally attached to the frame, comprising a front load platform and a rear load platform. The load platforms are pivotal between a deployed position defined by the load platforms being positioned substantially perpendicular to the longitudinal axis of the frame and a stored position defined by the load platforms being positioned substantially parallel to the longitudinal axis of the frame. Raising of the front load platform causes the lower pair of wheels to rotate inwardly from a position extending backwardly from the frame of the hand truck to a position in which the lower pair of wheels is folded into and nested with the frame of the hand truck, thereby substantially reducing the width of the hand truck. Likewise, raising of the rear load platform causes the upper pair of wheels to rotate inwardly, to be folded and nested into the frame of the hand truck. When in the folded configuration, embodiments of the hand truck present a small width profile, thereby facilitating transporting and storing the hand truck when it is not in use. Embodiments of the hand truck may also comprise pivotable table surfaces which may be utilized as portable work benches, power tool platforms, or comparable uses.

There has thus been outlined, rather broadly, the more important features of the disclosed device in order that the detailed description thereof that follows may be better understood, and in order that the present contribution to the art may be better appreciated.

### BRIEF DESCRIPTION OF THE DRAWINGS

FIG. 1 shows a front perspective view of an embodiment of the disclosed hand truck.

FIG. 2 shows a side view of an embodiment of the disclosed hand truck.

FIG. 3 shows a rear perspective view of an embodiment of the hand truck.

FIG. 4 shows a perspective view of an embodiment of the hand truck collapsed for storage.

FIG. 5 shows a side view of an embodiment of the disclosed hand truck, showing the width of the device in the collapsed position.

FIG. 6 shows a front view of an embodiment of the hand truck in the collapsed position

FIG. 7 shows an exploded view of an embodiment of the hand truck

FIGS. 8 and 8A show the upper cross-brace member, and an exploded view of the upper cross-brace member.

FIG. 9 shows an exploded view of a locking device which may be utilized to lock the upper and lower wheels in position.

FIG. 10 shows an exploded view of one of the upper wheel assemblies.

FIG. 11 shows an exploded view of one of the lower wheel assemblies.

FIGS. 12, 12A and 12B shows a front perspective view of an embodiment of the hand truck, showing a gear configuration which may be utilized for actuating the different pairs of wheels into the stored positions by respective manipulation of the front load platform and the rear load platform.

FIG. 13 shows a close up view of an embodiment of the front load platform.

FIG. 14 shows a close up view of an embodiment of the rear load platform.

FIG. 15 shows a close up view of an embodiment of optional sand wheels which may be disposed between the lower pair of wheels, where the sand wheels facilitate transport of the hand truck across sand, mud and other difficult terrain.

FIG. 16 shows an embodiment of the hand truck which comprises an optional table member.

FIGS. 17-19 show a detailed view of an embodiment of the front load platform, showing how bevel gears may be disposed on the front load platform to engage bevel gears mounted to the wheel support members, indicating how raising the front load platform causes the wheel support members and wheels to rotate into the stored position.

FIG. 20 shows a rear view of another embodiment of the hand truck which comprises optional table members on the front and the back, with the table members in the traveling configuration, with the front load platform and rear load platform deployed.

FIG. 21 shows a front perspective view of the embodiment shown in FIG. 20 with the table members in the traveling configuration.

FIG. 22 shows a side perspective view of the embodiment shown in FIG. 21.

FIG. 23 shows a side perspective view of the embodiment shown in FIG. 21 with the tables deployed for use.

### DESCRIPTION OF THE EMBODIMENTS

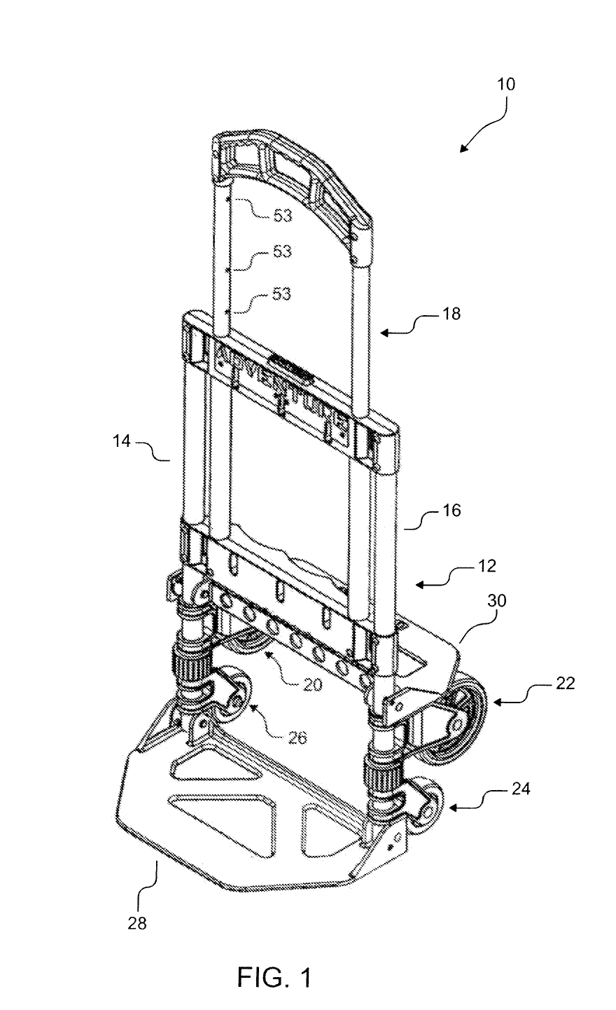

FIG. 1 shows a rear perspective view of an embodiment of the hand truck 10, which generally comprises frame 12 having side members 14, 16, which define a plane. Hand truck 10 further comprises a handle assembly 18. Also shown are a pair of pivotally attached upper wheel assemblies 20, 22, and the pivotally attached lower wheel assemblies, 24, 26. The front load platform 28 is pivotally attached to the front of the frame 12. Front load platform 28 is pivotable from a first position generally perpendicular to the plane defined by side members 14, 16, as shown in various figures, including FIGS. 1 through 3. Rear load platform 30 is pivotally attached to the back of the frame 12. In FIGS. 1 through 3, the front load platform 28 and the rear load platform 30 are in the operational position, ready for use. In this position, the front load platform 28 and the rear load platform are generally perpendicular to the plane defined by side members 14,16.

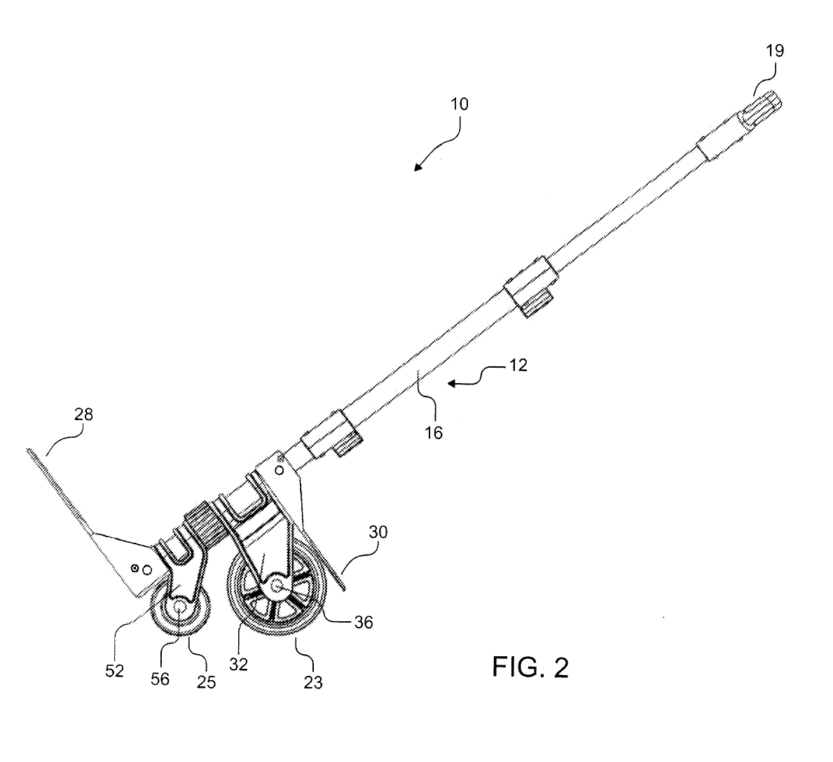

The presently disclosed hand truck, because of its configuration having a front load platform 28 and rear load platform 30, may be loaded such that the load on the front load platform and the rear load platform tend to impose opposing moments making the hand truck easier for the user to handle. For example, with reference to FIG. 2, a load disposed on front load platform 28 would impose a counter-clockwise moment on the hand truck, while a load disposed on rear load platform 30 would impose a clockwise moment, such that the two moments would tend to cancel each other, thus reducing the load at handle member 19. As a result, the amount of effort required by the user to maintain the hand truck in position for transporting the loads is reduced. Moreover, the addition of the upper pair of wheel assemblies 20, 22 largely support the load once the hand truck has been pivoted from a vertical position to 35 to 40 degrees from the horizontal, at which point the wheels 21, 23 of the upper pair of wheel assemblies engage the ground surface. This feature demonstrates the utility of having the larger set of wheels in the upper position, as explained in greater detail below.

As shown in the Figures, the diameter of the upper wheels 21, 23 and the diameter of the lower wheels 25, 27, are sized such that when the frame 12 approaches a particular angle with the ground surface, such as between 35-40 degrees, both the upper wheels and the lower wheels are placed in engaging contact with the ground surface. The inventor herein has found that utilizing lower wheels 25, 27 having an outside diameter of 3.5 inches and upper wheels 21, 23 having an outside diameter of 6 inches allows both the lower wheels and the upper wheels to have ground engaging contact when the plane defined by the side members 14, 16 is at an angle of approximately 37 degrees from a horizontal ground service.

Upper wheel assemblies 20, 22 respectfully comprise upper wheels, 21, 23, which are respectively mounted within upper wheel support members 32, 34, and rotate upon axles 36, 38. Polyurethane is an acceptable material for both the upper wheels 21, 23 and the lower wheels 25, 27. As shown in FIGS. 1 and 2, when the upper wheels 21, 23 are in the operating position (i.e., ready to transport loads), the axles 36, 38 are generally parallel to the plane defined by side members 14, 16. Lower wheel assemblies 24, 26 respectfully comprise lower wheels 25, 27, which are respectively mounted within lower wheel support members 52, 54 and rotate upon axles 56, 58.

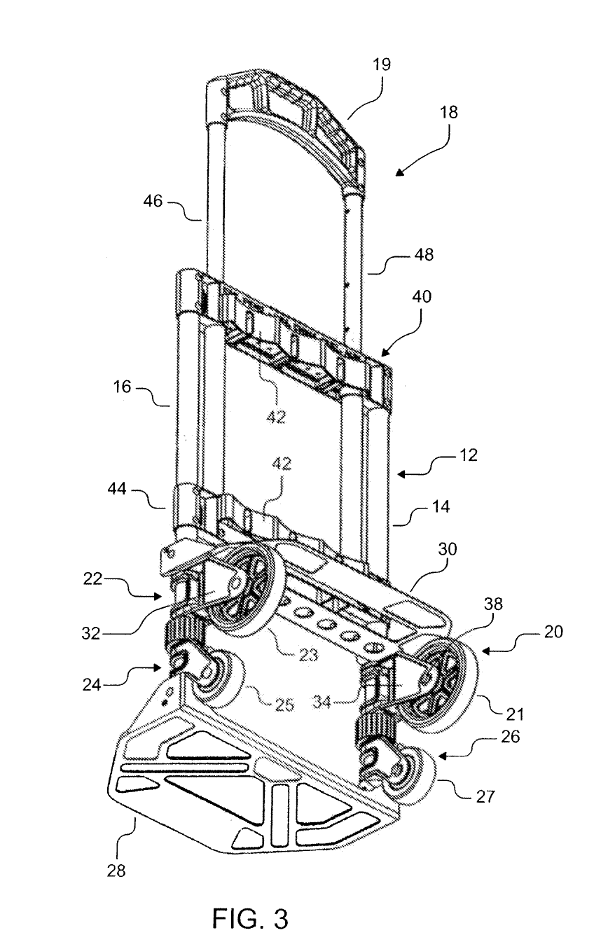

FIG. 3 shows a rear view of an embodiment of the hand truck, and shows the pair of side members 14, 16, and handle member 19. As shown in FIG. 3, an embodiment of the hand truck may comprise an upper cross brace 40 and a lower cross brace 44, each which may comprise scallops 42. The upper cross brace 40 and the lower cross brace 44 support the handle support tubes 46, 48 which terminate in handle 19. The handle support tubes 46, 48 may comprise telescoping tubes which allow the handle assembly 18 to collapse toward the cross brace 40 for reducing the size of the hand truck 10 into the storage position. The upper cross brace 40 and the lower cross brace 44 may also provide support for various cargo transported on the hand truck. For example, scuba tanks may be transported on the rear load platform 30, and the scallops 42 may be fashioned to match the contour of the scuba tanks, thus providing additional support for the tanks, particularly if flexible cords are utilized to secure the tanks to the hand truck.

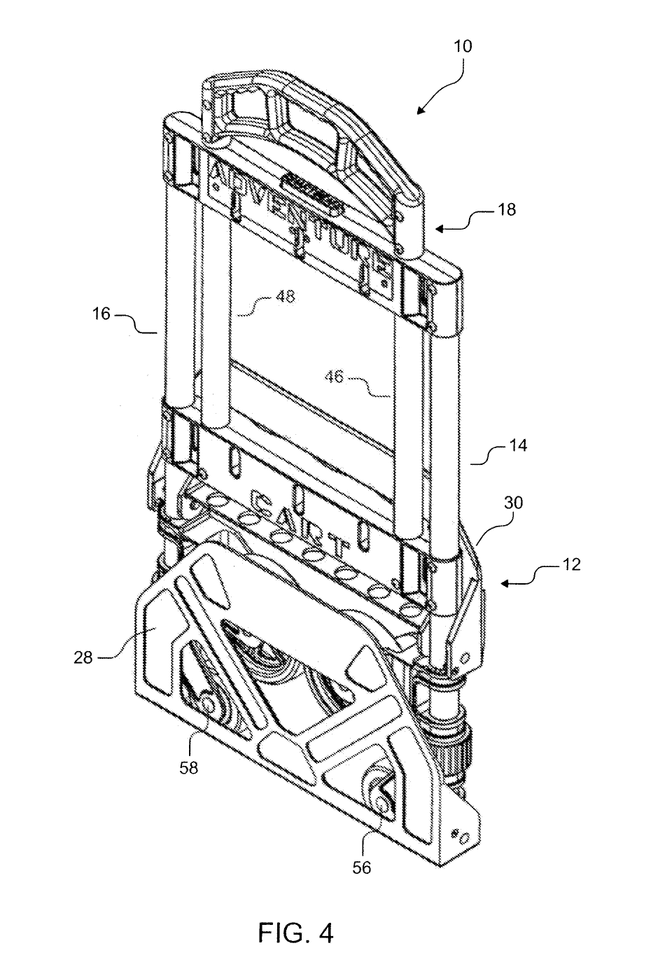

FIG. 4 shows a front view of an embodiment of the hand truck in the storage position. In this position, the front load platform 28 and the rear platform 30 are both raised such that they each parallel to the plane defined by side members 14, 16. As the front load platform 28 is raised, the lower pair of wheel assemblies 24, 26 are folded and nested into the frame 12, such that the orientation of axles 56, 58 changes being generally parallel to the plane defined by side members 14, 16 to being perpendicular to the plane. Likewise, as rear platform 30 is raised, the upper pair of wheel assemblies 20, 22 are folded and nested into the frame 12, and the orientation of axles 36, 38 changes from generally parallel to the plane to perpendicular to the plane. Handle assembly 18 may include telescoping handle support tubes 46, 48 which allow the handle assembly to collapse resulting in greater compaction of the device.

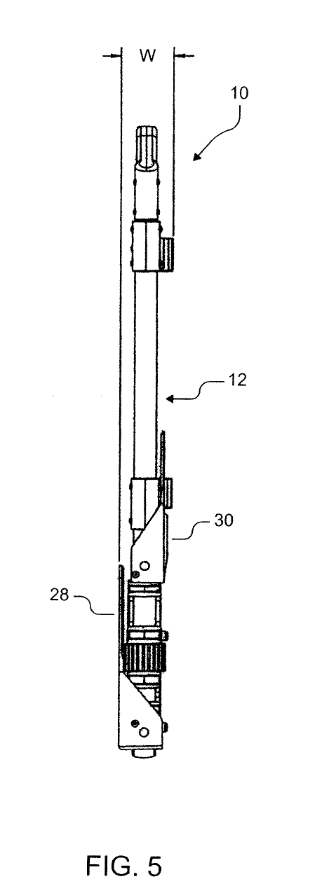

FIG. 5 shows a side view of an embodiment 10 of the hand truck shown in the storage position. FIG. 5 illustrates how the size of the hand truck may be substantially reduced when placed in the storage position. As shown in this Figure, when the hand truck is collapsed with the front load platform 28 and the rear load platform 30 folded up against frame 12, the width of the hand truck may be reduced to dimension W, which may be less than three inches for some embodiments of the hand truck. This reduced thickness is achieved by pivoting the pair of upper wheel assemblies 20, 22 and the pair of lower wheel assemblies 24, 26 inwardly, such that upper pair of wheel assemblies are generally flush with the members of frame 12. Likewise, the lower pair of wheel assemblies 24, 26 fold into and nest within the members of frame 12 and are generally flush with the members of frame 12.

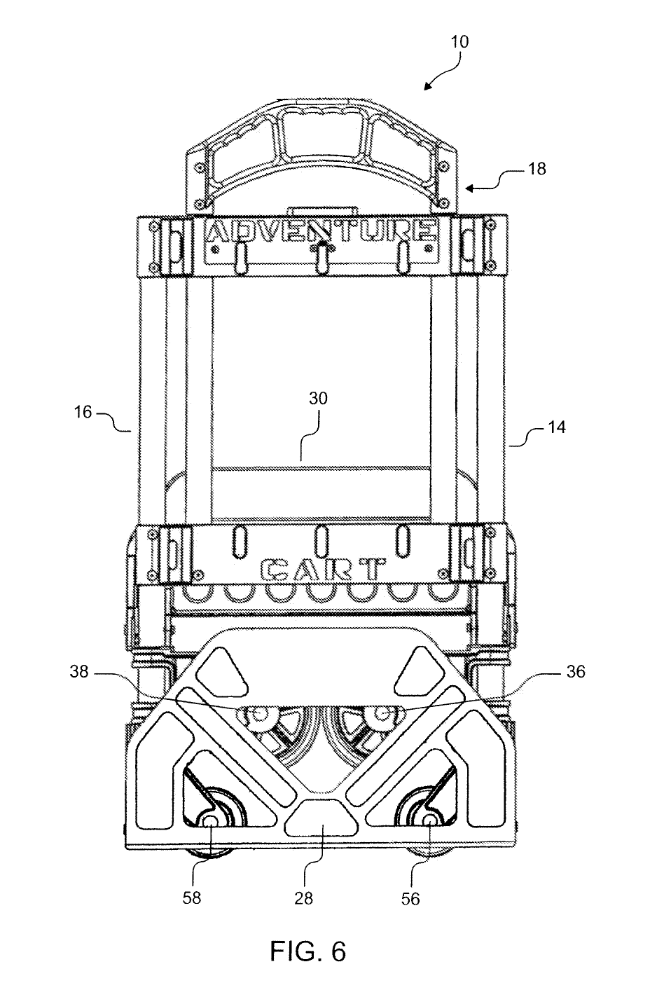

FIG. 6 shows a front view of an embodiment of the hand truck in the storage position, with the upper pair of pivotally attached wheel assemblies 20,22 and the lower pair of pivotally attached wheel assemblies 24, 26 each nested within the members of frame 12. FIG. 6 shows how the overall height may be reduced by telescoping the handle assembly 18.

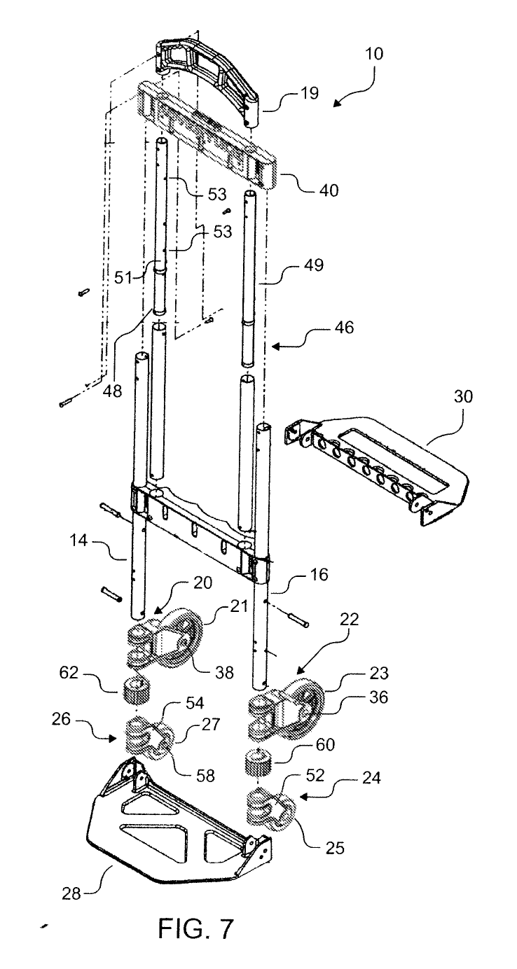

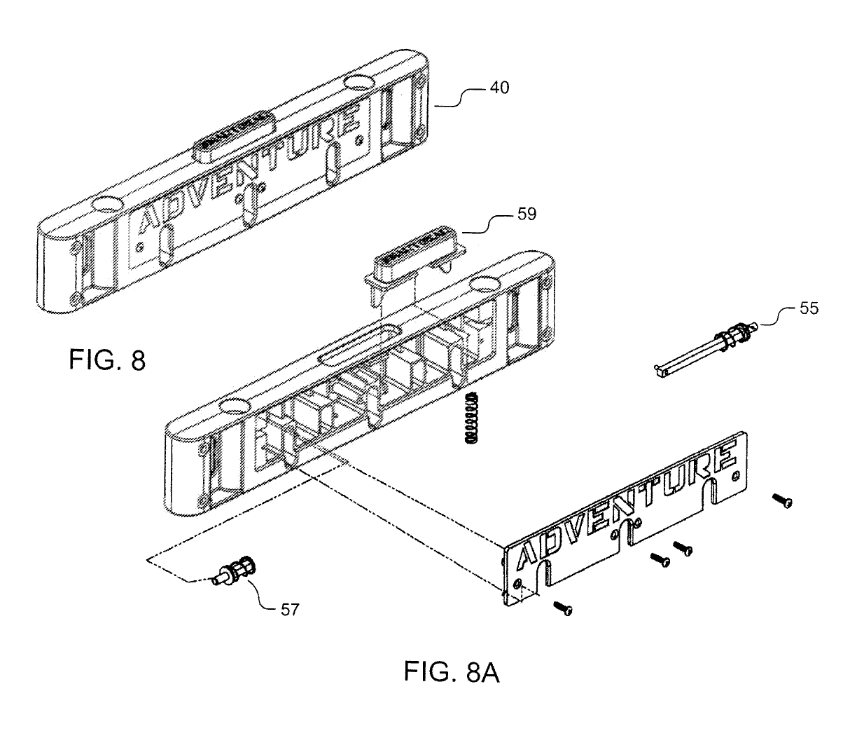

FIG. 7 shows an exploded view of an embodiment of the hand truck 10. As shown in this figure, handle assembly 18 may include telescoping handle support tubes 46, 48 which allow the handle assembly to collapse resulting in greater compaction of the device. The inside tubes 49, 51 may comprise apertures 53 into which latch members 55, 57, may be set. As shown in FIG. 8, latch members 55, 57 may be set within upper cross brace 40. As further shown in FIG. 8, a release button 59 disposed within upper cross brace 40 to release the latch members 55,57 from the apertures 53 to allow the collapsing of the handle assembly 18.

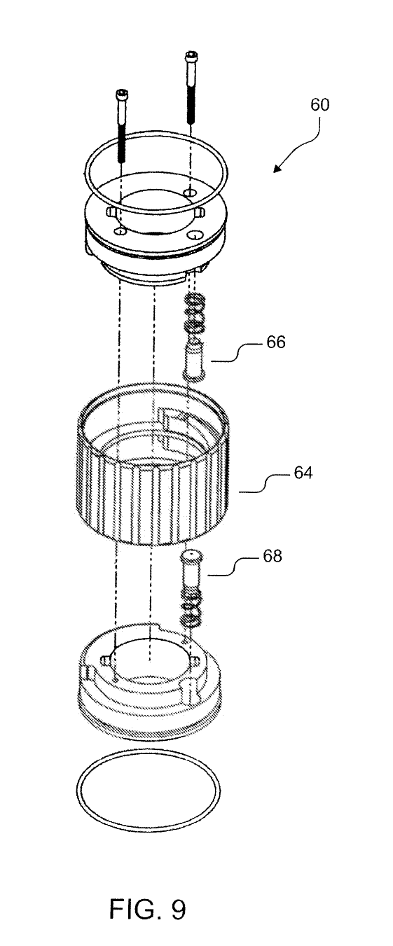

Among the other things shown in FIG. 7, an embodiment of the hand truck 10 may comprise locking mechanisms 60, 62 which may be utilized to lock the upper wheel assemblies 20,22 and the lower wheel assemblies 24, 26 from rotating. A detailed view of the locking mechanisms 60, 62 is shown in FIG. 9. As shown in FIG. 9, the locking mechanism 60, 62 comprise a sleeve 64 which, as the sleeve is rotated, urges upper pin 66 upward into engagement apertures (not shown) in the upper wheel support members 32, 34. Likewise, as sleeve 64 is rotated, it also urges lower pin 68 downwardly into engagement apertures 70 in the lower wheel support members 52, 54.

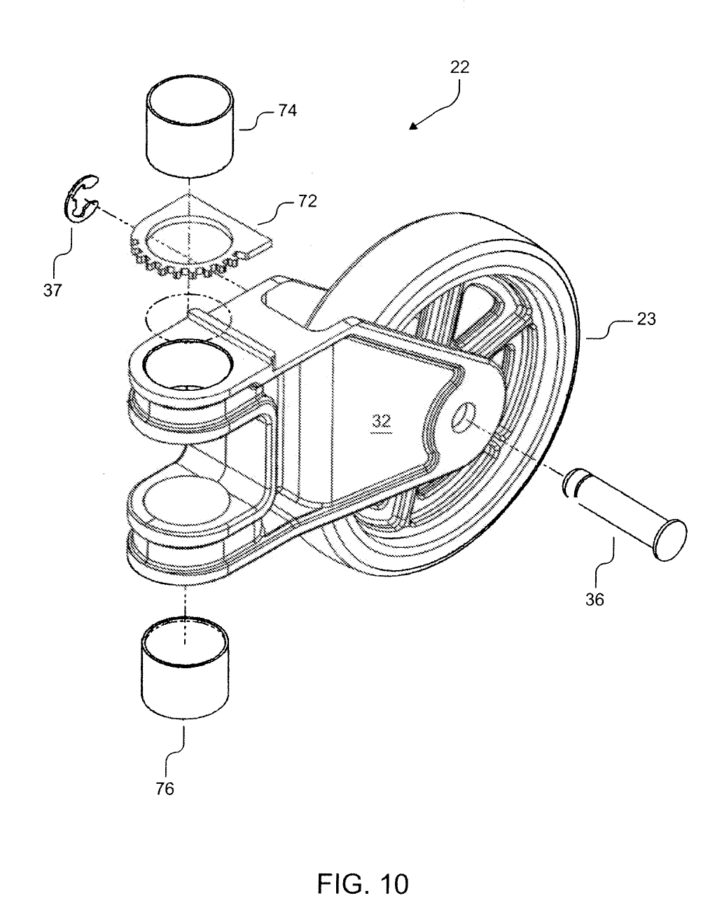

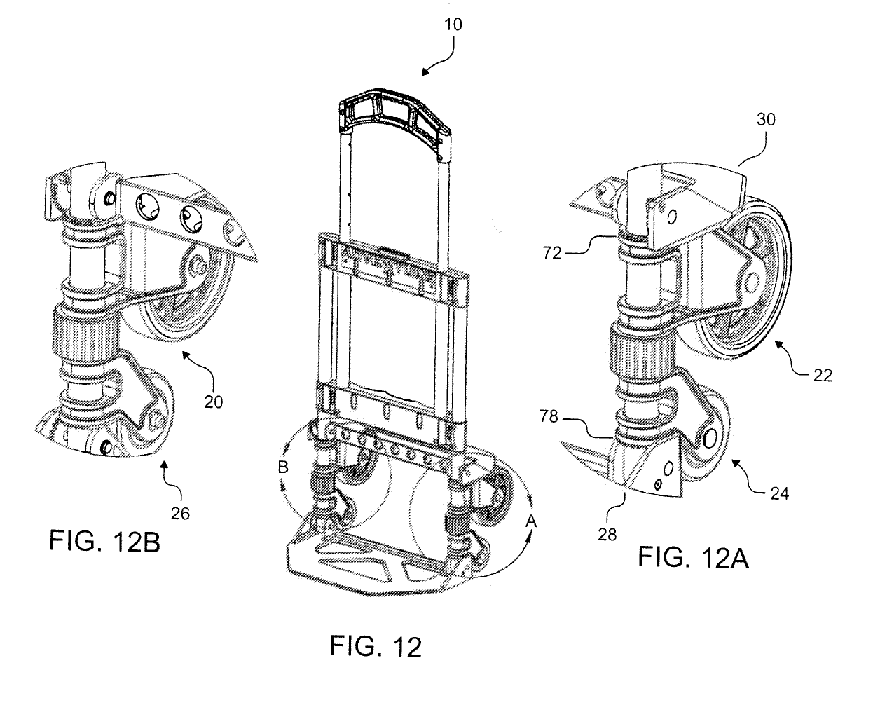

FIG. 10 shows a detailed view of upper wheel assembly 22 which may be utilized with the present invention. Upper wheel assembly 22 comprises wheel 23, upper wheel support member 32, and axle 36. Also shown is semi-circular gear 72, upper bushing 74, and lower bushing 76. Axle 36 is retained by lock ring 37. The upper wheel assembly 20 utilized on the opposite side of the hand truck is identical to upper wheel assembly 22, except the orientation of the semi-circular gear 70 is reversed to allow for rotation of the wheel assembly in the opposite direction. The mechanisms utilized for rotating the upper wheel assemblies 20, 22 are shown in FIGS. 12 and 12A

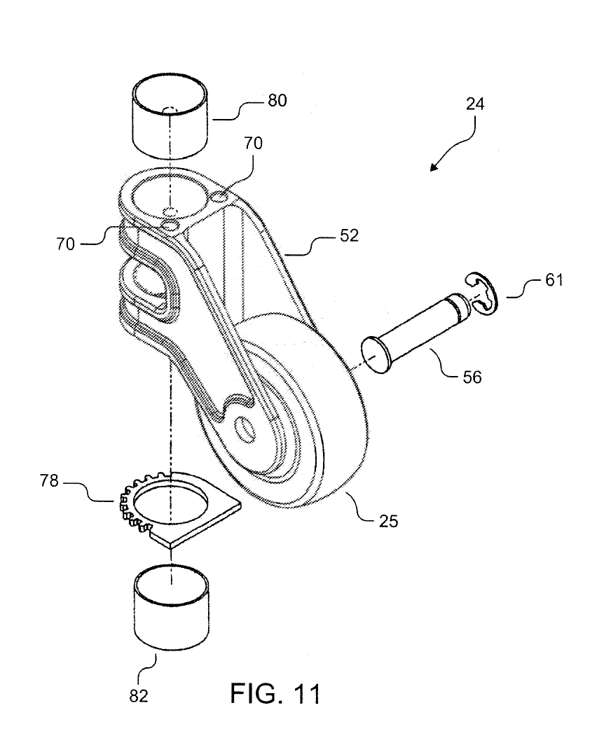

FIG. 11 shows a detailed view of lower wheel assembly 24 which may be utilized with the present invention. Lower wheel assembly 24 comprises wheel 25, lower wheel support member 52, and axle 56. Also shown is semi-circular gear 78, upper bushing 80 and lower bushing 82. Axle 56 is retained by lock ring 61. The lower wheel assembly 26 utilized on the opposite side of the hand truck is identical to lower wheel assembly 24, except the orientation of the semi-circular gear 78 is reversed to allow for rotation of the wheel assembly in the opposite direction. The mechanisms utilized for rotating the lower wheel assemblies 24, 26 are shown in FIGS. 12 and 12B.

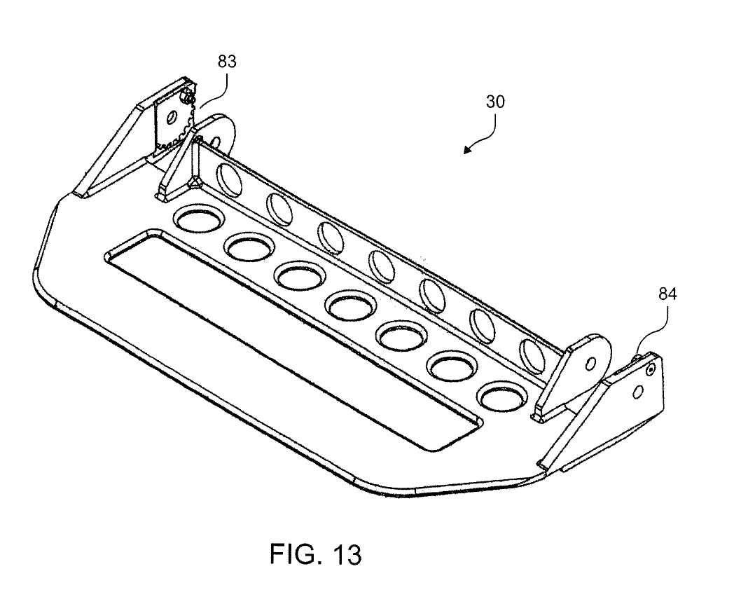

FIG. 13 shows an embodiment of a rear load platform 30 which may be utilized with the present invention. As shown in FIG. 13, the rear load platform 30 may comprises a pair of opposite facing semi-circular gears 83, 84. The semi-circular gears 83, 84 engage the teeth of semi-circular gears 72 of the upper wheel assemblies 20, 22 when the rear load platform is raised or lowered to move the upper wheel assemblies back and forth from the operational and storage positions. It is to be appreciated that the rear load platform 30 may comprise various cut-outs, lips, etc. which may be utilized for various types of cargo. For example, rear load platform may comprise contoured indentions for securing the bottom of scuba tanks.

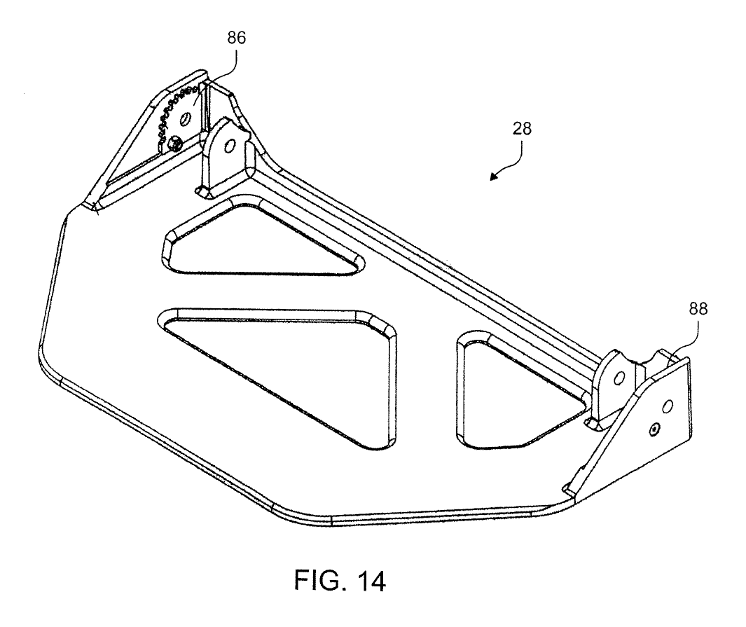

FIG. 14 shows an embodiment of a front load platform 28 which may be utilized with the present invention. As shown in FIG. 14, the front load platform 28 may comprises a pair of opposite facing semi-circular gears 86, 88. The semi-circular gears 86, 88 engage the teeth of semi-circular gears 78 of the lower wheel assemblies 24, 26 when the front load platform is raised or lowered thus moving the lower wheel assemblies back and forth from the operational and storage positions. As with the rear load platform 30. the front load platform 28 may comprise various cut-outs, lips, etc. which may be utilized for various types of cargo.

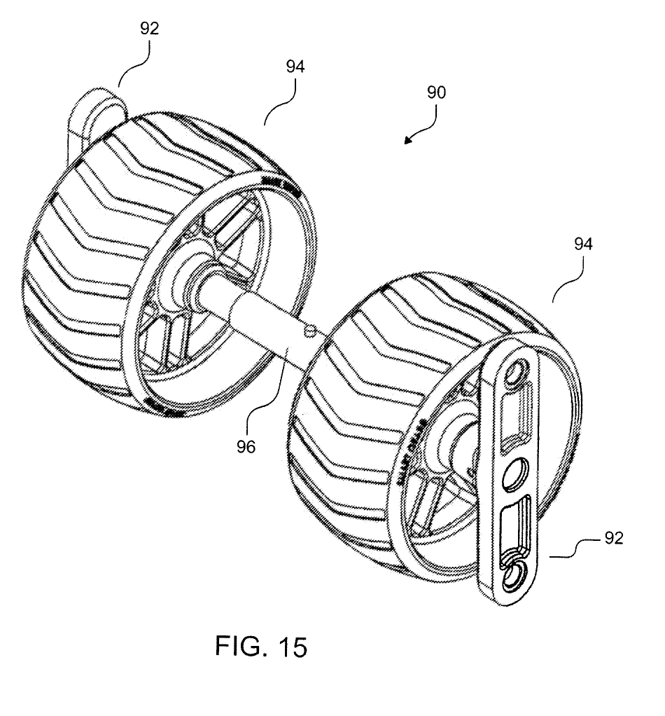

FIG. 15 shows an optional wheel assembly 90 which may be utilized with embodiments of the disclosed hand truck. The optional wheel assembly 90 may be disposed between the lower pair of wheel assemblies, by attaching mounting brackets 92 to frame 12. The relatively large diameter wheels 94 facilitate use of the hand truck on sand, mud and other difficult terrain. Large diameter wheels 94 are mounted to axle 96.

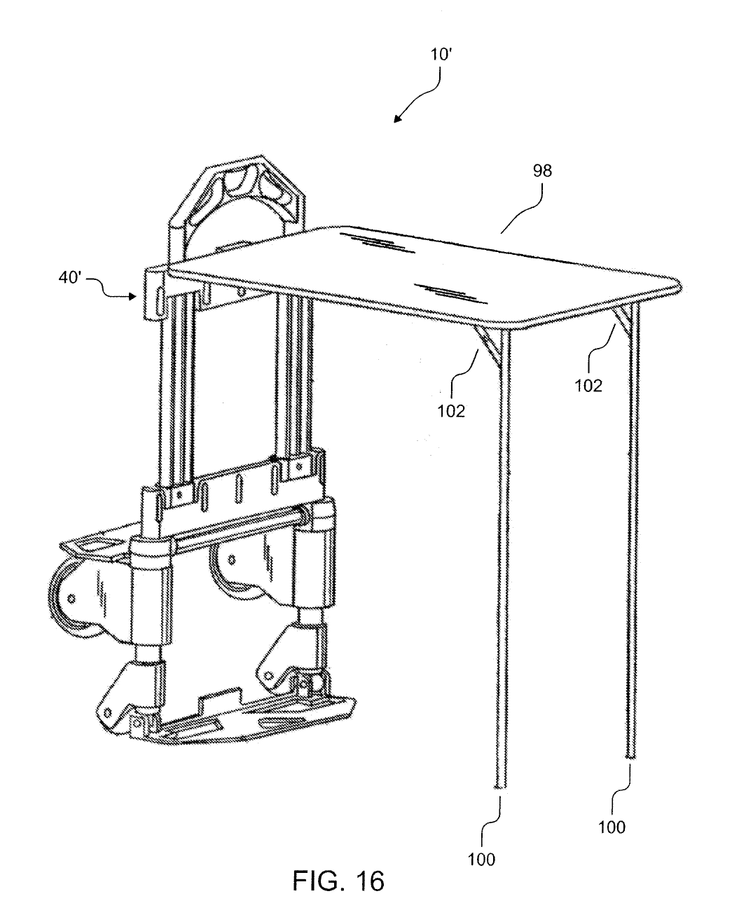

FIG. 16 shows an alternative embodiment of the hand truck 10′. This embodiment comprises a table member 98 which may be attached to the upper cross brace 40′ or other structure of the hand truck 10′. The table member 98 may comprise one or more leg members 100 which may be pivotally attached to the bottom of the table member. Support 102 may be utilized to provide additional stability to the table member 98.

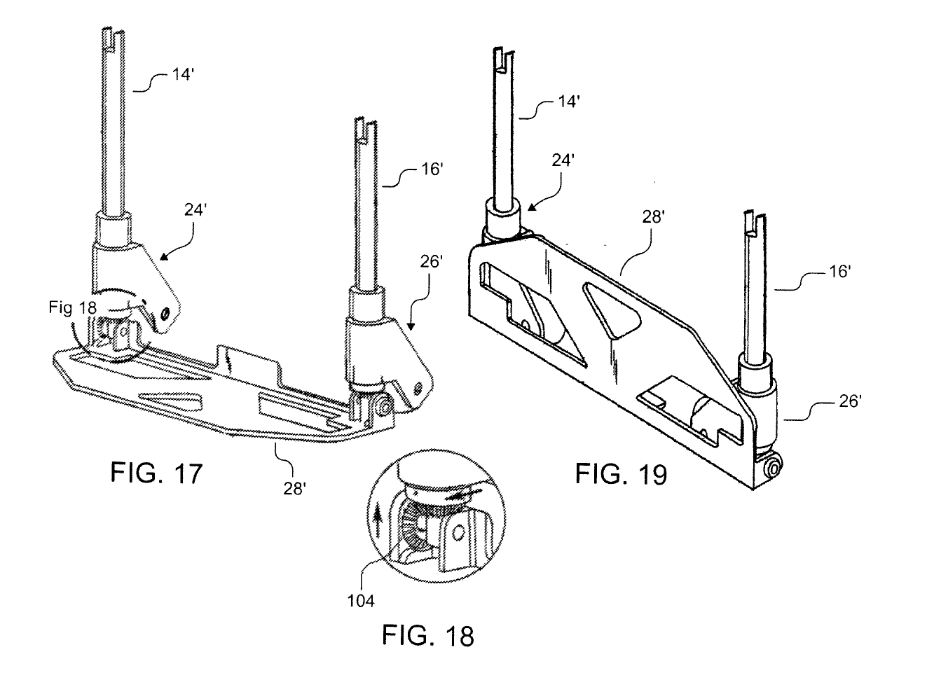

FIGS. 17 through 19 show an alternative gear arrangement which may be utilized as opposed to the semi-circular gears discussed above. FIGS. 17 through 19 show the use of bevel gears 104 for manipulating the lower wheel assemblies 24′, 26′ by the raising and lowering of front load platform 28′. The arrows indicate the direction the side members are turned to drive the gears. Shown are portions of side members 14′ and 16′.

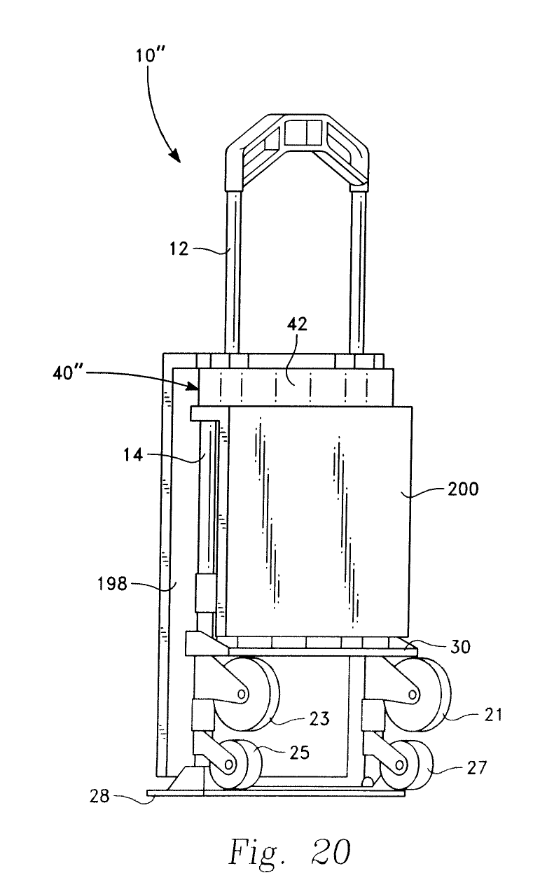

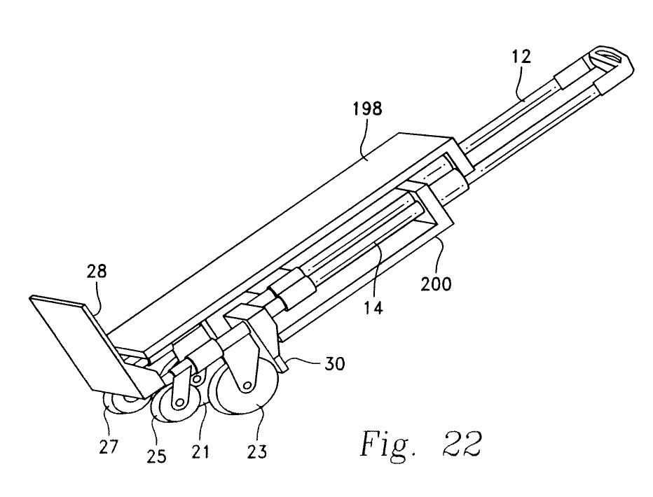

FIGS. 20 through 23 shows an alternative embodiment of the hand truck 10″. This embodiment comprises front table member 198 and rear table member 200 which may be attached to the upper cross brace 40″ or other structure of the hand truck 10″. The table surfaces 198, 200 are stowed or stored against the frame 12, and can be self-retaining or can be closed with straps, buckles, latches or any other known means of retention.

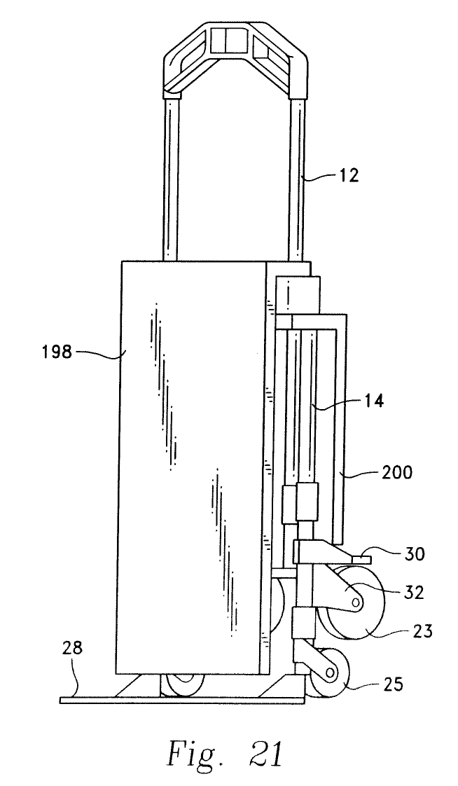

FIG. 21 shows a left side view of an embodiment of the hand-truck 10″ shown in FIG. 20. The front load platform 28 and rear load platform 30 are shown in the deployed position, as are the upper wheels 21, 23, and the lower wheels 25, 27. The front table member 198 and the rear table member 200 are hingedly attached to the frame 12, and pivot upwards away from the frame 12 when deployed, such that the front table member and the rear table member cantilever from the frame. The front table member 198 and the rear table member 200 can also comprise indicia for measurement or alignment of work pieces, for the display of common safety information, or for display of formulae for converting between commonly used weights, lengths or similar measurements. The front table member 198 and rear table member 200 may also comprise apertures or slots which are configured to receive anchoring mechanisms for various types of tools, such as radial saws, grinders, jig saw, etc., such that the table members form a portable work bench. The front table member 198 and the rear table member 200 may also comprise a partial or a total magnetic surface to which metal tools or metal parts would be retained for ease of use and secure retention. Additionally, when using the table surface as a desk, magnetic paper holders could be used to retain working papers and prevent the papers from blowing away or otherwise being disturbed.

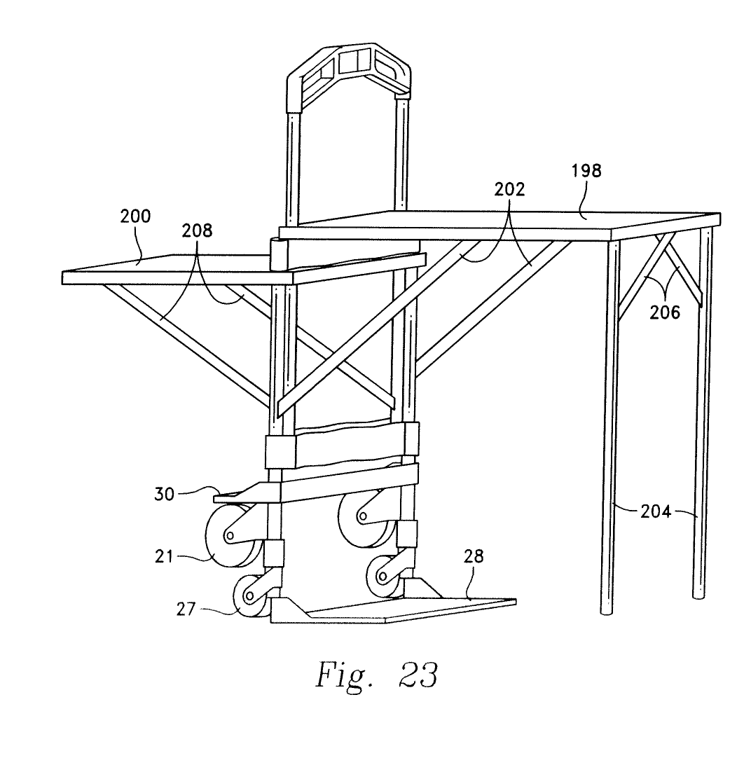

FIG. 23 shows a perspective view of an embodiment of the utility hand-truck with the front table member 198 and rear table member 200 in the deployed positions Front table member 198 may be supported by braces 202 shown, or by an alternate method of support. Front table member 198 may also comprise legs 204. The legs 204 may also comprise telescopic legs. Legs 204 may also comprise supports 206. The attachment to frame 12 may comprise slidable attachment means such that the height of front table member 198 may be adjusted to different heights for different needs.

Rear table member 200 may be configured to have a shorter length than front table member 198, such that the rear table member is cantilevers from 12 without supporting legs, as depicted in FIG. 23. Rear table member 200 may further comprise support members 208. As shown by the configuration in FIG. 23, the opening in frame 12 allows access between the surfaces of front table member 198 and rear table member 200. This feature can be useful in different configurations. For example, if utilized as a work bench, a saw might be attached to front table member 198, and a long member to be cut, such as a board, might be spanned across the front table member 198 and the rear table member 200, so that the long member may be fed into the saw.

While the above is a description of various embodiments of the present invention, further modifications may be employed without departing from the spirit and scope of the present invention. Thus the scope of the invention should not be limited according to these factors, but according to the following claims.

What is claimed is:

1. A utility hand truck comprising:
a frame member comprising a handle assembly and a pair of parallel side members, the frame member further comprising a front and a back, and the side members defining a plane;
a front load platform pivotally attached to the front of the frame member, the front load platform pivotable from a first position generally perpendicular to the plane to a second position generally parallel to the plane;
a lower pair of wheels, each wheel pivotally connected to one of the side members, the lower pair of wheels each comprising an axis, the lower pair of wheels rotatable from a first position wherein the axis of each of the lower wheels is generally parallel to the plane to a second position wherein the axis of each of the lower wheels is generally perpendicular to the plane, the lower pair of wheels actuated from the first position to the second position by the pivoting of the front load platform from the first position to the second position;
a rear load platform pivotally attached to the back of the frame member, the rear load platform pivotable from an operation position generally perpendicular to the plane to a storage position generally parallel to the plane; and
an upper pair of wheels, each wheel pivotally connected to one of the side members, the upper pair of wheels each comprising an axis, the upper pair of wheels rotatable from an operation position wherein the axis of each of the upper wheels is generally parallel to the plane to a storage position wherein the axis of each of the upper wheels is generally perpendicular to the plane, the upper pair of wheels actuated from the operation position to the storage position by the pivoting of the rear load platform from the operation position to the storage position, and the diameters of each of the wheels in the upper pair are larger than the diameters of each of the wheels in the lower pair.

2. The utility hand truck of claim 1 wherein the handle assembly comprises a cross member attached to a pair of parallel support members wherein a portion of each of the parallel support members is in parallel alignment with a portion of each of the side members.

3. The utility hand truck of claim 2 wherein each support member comprises telescoping tubes.

4. The utility hand truck of claim 1 wherein the front load platform comprises a pair of semicircular gear members.

5. The utility hand truck of claim 1 wherein the rear load platform comprises a pair of semicircular gear members.

6. The utility hand truck of claim 1 wherein the front load platform comprises a pair of beveled gear members.

7. The utility hand truck of claim 1 wherein the rear load platform comprises a pair of beveled gear members.

8. The utility hand truck of claim 5 wherein each wheel of the upper pair of wheels is attached to a side member with an upper wheel support member.

9. The utility hand truck of claim 8 wherein each upper wheel support member comprises a plurality of engagement teeth, wherein the engagement teeth on each upper wheel support member engage the teeth of the corresponding semicircular gear member of the rear load platform as the rear load platform is pivoted between the operation position and the storage position.

10. The utility hand truck of claim 4 wherein each wheel of the lower pair of wheels is attached to a side member with a lower wheel support member.

11. The utility hand truck of claim 10 wherein each lower wheel support member comprises a plurality of engagement teeth, wherein the engagement teeth on each lower wheel support member engage the teeth of the corresponding semicircular gear member of the front load platform as the front load platform is pivoted between the first position and the second position.

12. The utility hand truck of claim 1 further comprising an lower cross brace.

13. The utility hand truck of claim 12 wherein the lower cross brace comprises a plurality of scallops.

14. The utility hand truck of claim 1 wherein a table member is pivotably attached to the frame member, wherein the table member comprises a leg member pivotally attached to the table member.

15. The utility hand truck of claim 1 wherein the hand truck comprises locking means for alternatively retaining the upper wheels in either the operation position or the storage position.

16. The utility hand truck of claim 1 wherein the utility hand truck comprises an operating configuration wherein the front load platform is in the first position, the lower pair of wheels are in the first position, the rear load platform is in the operation position and the upper pair of wheels are in the operation position and the utility hand truck comprises a storage configuration wherein the front load platform is in the second position, the lower pair of wheels are in the second position, the rear load platform is in the storage position and the upper pair of wheels are in the storage position.

17. The utility hand truck of claim 16 wherein the lower pair of wheels and the upper pair of wheels are flush with the side members when the utility hand truck is in the storage position.

18. The utility hand truck of claim 17 wherein the dimension from the front to the back of the utility hand truck in the storage position is less than three inches.

19. The utility hand truck of claim 1 further comprising a pair of sand wheels disposed between the lower pair of wheels.

20. The utility hand truck of claim 1 wherein upper pair of wheels and the lower pair of wheels are in simultaneous contact with a rolling surface when the angle between the frame and the rolling surface is from 35 to 40 degrees.
